(19) United States
(12) Patent Application Publication
(10) Pub. No.: US 2026/0029903 A1
(43) Pub. Date: Jan. 29, 2026

(54) WEB BROWSING DATA VISUALIZATION IN A 3D VIRTUAL ENVIRONMENT

(71) Applicant: FMR LLC, Boston, MA (US)

(72) Inventors: Lukasz Karol Porwol, Galway (IE); Cecelia Kay Brooks, Pelham, NH (US); Peter Joseph McCormack, Co. Wexford (IE); Jason McEvoy, Co. Wicklow (IE)

(21) Appl. No.: 18/784,224

(22) Filed: Jul. 25, 2024

(51) Int. Cl. G06F 3/04842; G02B 27/00; G02B 27/01; G06F 3/01; G06F 3/04845; G06T 15/00

(52) U.S. Cl. CPC G06F 3/04842; G02B 27/0093; G02B 27/017; G06F 3/013; G06F 3/04845; G06T 15/005

(57) ABSTRACT

Methods and apparatuses for web browsing data visualization in a 3D virtual environment include a computing device that renders a first panel in the 3D virtual environment to display to a user a first webpage associated with a first URL. The computing device stores a first identifier associated with the first webpage in a web path data structure. The computing device detects a first user interaction with the first panel, comprising a request to access a second webpage associated with a second URL. The computing device renders a second panel that displays the second webpage, the second panel arranged in proximity to a first side of the first panel and extending in a first direction in the 3D virtual environment. The computing device stores a second identifier associated with the second webpage in the web path data structure, the second identifier sequentially linked to the first identifier.

### TECHNICAL FIELD

This application relates generally to methods and apparatuses, including computer program products, for web browsing data visualization in a three-dimensional (3D) virtual environment.

### BACKGROUND

In traditional computing interfaces, i.e., two-dimensional (2D) screens, the ability of users to efficiently perform data exploration techniques is very limited. As one example, a user may want to perform web-based research using browser software (e.g., Google® Chrome™, Apple® Safari™, Microsoft® Edge™). Typically, the user must open many different tabs or windows that each contain a separate webpage or single view of data, in order to conduct a research journey to drill down on various topics yet still retain the overall context of the analysis. In some cases, the user may be forced to undergo an interruption or disconnect of their train of thought when switching between tabs or views. Even then, the 2D user interface is not conducive to arranging the various tabs and windows in a manner that enables the user to retrace their steps or build out additional research threads/paths. Often, a user requires multiple screens or devices to accomplish this type of visualization.

The advancement of three-dimensional (3D) computing interfaces, such as alternative reality hardware and software applications, has enabled the experience in which a user's real-world viewing perspective is replaced by or enhanced with a virtual 3D environment. Generally, the term “alternative reality” encompasses all different types of virtual experiences, including but not limited to: virtual reality (VR), augmented reality (AR), mixed reality (MR), extended reality (XR) and others. A user wears a headset or similar apparatus that includes specialized display devices to render the virtual environment to the user, and the headset can include certain components (e.g., gyroscope(s), accelerometer(s), magnetometer(s), etc.) that detect and capture the user's head movements in order to update the virtual environment in response to the movements in a seamless, real-time manner. An emerging type of software application being used in alternative reality environments is data exploration, where data repositories can be leveraged to generate 3D objects in the alternative reality environment that correspond to data points within one or more databases. A user of the alternative reality software application can be ‘immersed’ in a virtual environment to view and manipulate 3D objects as part of the data exploration.

### SUMMARY

Therefore, what is needed are methods and systems that provide an immersive virtual environment for users to explore their web browsing sessions in a more dynamic and interactive 3D paradigm. The techniques described herein beneficially enable users to capture and store their web browsing history in a maze-like format, consisting of 3D panels and paths that represent the user's research journey from beginning to end. The 3D environment is continually updated as the user continues their journey, through the adaptation of existing 3D panels and insertion of new 3D panels to display a customized visual representation of one or more browsing sessions.

The invention, in one aspect, features a system for web browsing data visualization in a 3D virtual environment. The system includes a computing device having a memory for storing computer-executable instructions and a processor that executes the computer-executable instructions. The computing device renders a first panel in the 3D virtual environment that displays to a user a first webpage associated with a first URL. The computing device stores a first identifier associated with the first webpage in a web path data structure. The computing device detects a first user interaction with the first panel from the user, the first user interaction comprising a request to access a second webpage associated with a second URL. The computing device renders a second panel in the 3D virtual environment that displays the second webpage, the second panel arranged in proximity to a first side of the first panel with a same orientation to the user as the first panel, and extending in a first direction in the 3D virtual environment. The computing device stores a second identifier associated with the second webpage in the web path data structure, the second identifier sequentially linked to the first identifier.

The invention, in another aspect, a computerized method for web browsing data visualization in a 3D virtual environment. A computing device renders a first panel in the 3D virtual environment that displays to a user a first webpage associated with a first URL. The computing device stores a first identifier associated with the first webpage in a web path data structure. The computing device detects a first user interaction with the first panel from the user, the first user interaction comprising a request to access a second webpage associated with a second URL. The computing device renders a second panel in the 3D virtual environment that displays the second webpage, the second panel arranged in proximity to a first side of the first panel with a same orientation to the user as the first panel, and extending in a first direction in the 3D virtual environment. The computing device stores a second identifier associated with the second webpage in the web path data structure, the second identifier sequentially linked to the first identifier.

Any of the above aspects can include one or more of the following features. In some embodiments, the computing device detects a user interaction with the second panel, the user interaction comprising a request to access a third webpage associated with a third URL; renders a third panel in the 3D virtual environment that displays the third webpage, the third panel arranged in proximity to a first side of the second panel with a same orientation to the user as the second panel, and extending from the second panel in the first direction; and stores a third identifier associated with the third webpage in the web path data structure, the third identifier sequentially linked to the first identifier and the second identifier.

In some embodiments, the computing device detects a second user interaction with the first panel, the second user interaction comprising a request to access a fourth webpage associated with a fourth URL; renders a fourth panel in the 3D virtual environment that displays the fourth webpage, the fourth panel arranged in proximity to a second side of the first panel with a different orientation to the user than the orientation of the first panel, and extending from the first panel in a second direction in the 3D virtual environment; and stores a fourth identifier associated with the fourth webpage in the web path data structure, the fourth identifier sequentially linked to the first identifier.

In some embodiments, the computing device renders a first line in the 3D virtual environment that traces a first path starting at the first panel, continuing to the second panel, and ending at the third panel. In some embodiments, the computing device renders a second line in the 3D virtual environment that traces a second path starting at the first panel and ending at the fourth panel.

In some embodiments, the computing device is a headset device comprising one or more of: a virtual reality (VR) headset, a mixed reality (MR) headset, or an augmented reality (AR) headset. In some embodiments, for each panel, the headset device tracks a duration that the user's gaze is directed toward the panel and stores the duration for the panel in the web path data structure. In some embodiments, for each panel, the headset device tracks a duration that the user is positioned in 3D space in front of the panel and stores the duration for the panel in the web path data structure.

In some embodiments, the computing device detects a third user interaction with the second panel, the third user interaction comprising a request to access a fifth webpage associated with a fifth URL; rotates the third panel in the 3D virtual environment so that the third panel is arranged in proximity to the first side of the second panel with a different orientation to the user than the orientation of the second panel, and extends from the second panel in a second direction; renders a fifth panel in the 3D virtual environment that displays the fifth webpage, the fifth panel arranged in proximity to the first side of the second panel with the same orientation to the user as the orientation of the second panel, and extending from the second panel in the first direction; and stores a fifth identifier associated with the fifth webpage in the web path data structure, the fifth identifier sequentially linked to the first identifier and the second identifier.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for web browsing data visualization in a 3D virtual environment.

FIG. 2 is a flow diagram of a computerized method of web browsing data visualization in a 3D virtual environment.

FIG. 3 is a diagram of a 3D environment depicting a requested webpage as a first panel.

FIG. 4 is a diagram of an exemplary web path data structure associated with one or more browsing sessions for a particular user.

FIG. 5 is a diagram of a 3D environment depicting a first webpage in a first 3D panel and a second webpage in a second 3D panel.

FIG. 6 is a diagram of the web path data structure corresponding to the first panel and the second panel of FIG. 5.

FIG. 7 is a diagram of a 3D environment depicting a first webpage in a first 3D panel, a second webpage in a second 3D panel, and a third webpage in a third 3D panel.

FIG. 8 is a diagram of the web path data structure corresponding to the first, second, and third panels of FIG. 7.

FIG. 9 is a diagram of a 3D environment depicting a plurality of panels that make up two web browsing paths.

FIG. 10 is a diagram of the web path data structure corresponding to the first, second, third, and fourth panels of FIG. 9.

FIG. 11 is a workflow diagram of a computerized method of creating panels for a web browsing session in a 3D environment.

FIG. 12 is an exemplary data format for representing a node in a web path data structure.

### DETAILED DESCRIPTION

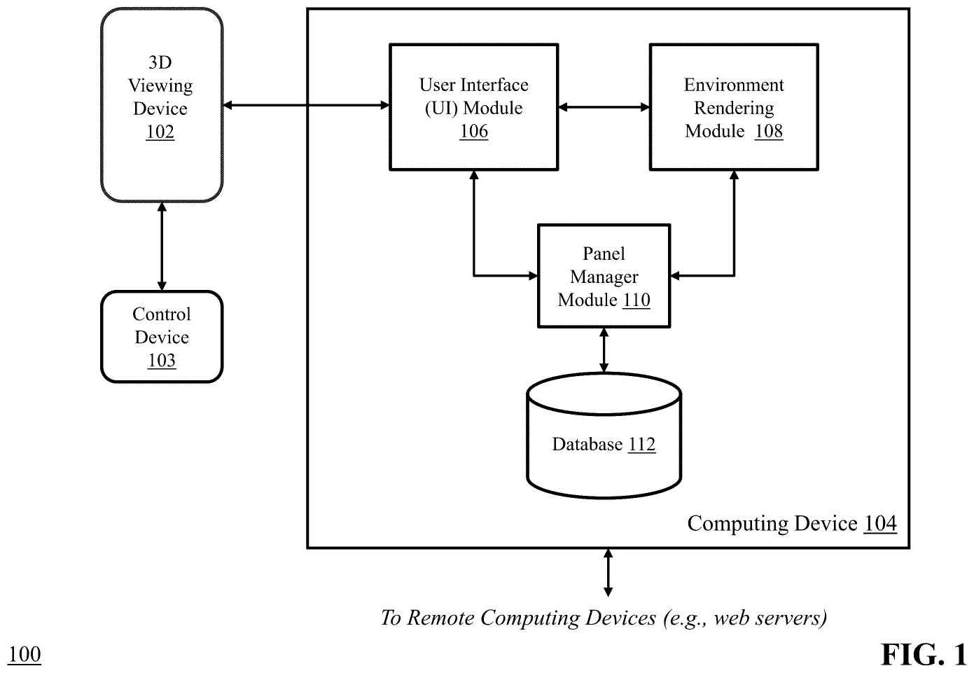

FIG. 1 is a block diagram of system 100 for web browsing data visualization in a 3D virtual environment. System 100 includes 3D viewing device 102, control device 103, and computing device 104 that includes user interface (UI) module 106, environment rendering module 108, panel manager module 110, and database 112.

3D viewing device 102 comprises an apparatus (e.g., headset, goggles, glasses, etc.) that enables a user to view a 3D virtual environment (such as a virtual reality (VR) environment, an augmented reality (AR) environment, a mixed reality (MR) environment, and/or an extended reality (XR) environment). Exemplary 3D viewing devices 102 can include, but are not limited to, the Meta Quest 3™ available from Meta Platforms, Inc., the Apple® Vision Pro™ available from Apple, Inc., and the HTC Vive XR Elite™ available from HTC Corp. 3D viewing device 102 connects to computing device 104 to receive data corresponding to a rendered 3D environment from computing device 104 for display to a user wearing device 102. In some embodiments, 3D viewing device 102 is coupled to computing device 104 via a physical connection (e.g., one or more cables hardwired using proprietary hardware connections to HDMI, USB and/or Display-ports of computing device 104). In some embodiments, 3D viewing device 102 is coupled to computing device 104 via a wireless network connection (e.g., WiFi™, Bluetooth™). In some embodiments, a communications network (e.g., LAN, WAN) is located between 3D viewing device 102 and computing device 104.

Further, 3D viewing device 102 is coupled to control device 103 which can comprise one or more devices that enable a user wearing 3D viewing device 102 to interact with the 3D virtual environment being rendered and displayed to the user. For example, control device 103 can be an apparatus such as a joystick, keypad, haptic controller, glove, and the like that the user holds and manipulates to provide input to computing device 104 for interaction with the 3D environment—including manipulation of objects within the environment. In this context, the user can provide input in many ways, including but not limited to performing gestures with control device 103, pressing one or more buttons on control device 103, moving control device 103 in relation to objects in the 3D environment, or any combination of the above. In some embodiments, the user can hold a plurality of control devices 103 (e.g., a joystick in each hand) to provide input to computing device 104.

Computing device 104 is a device including specialized hardware and/or software modules that execute on one or more processors and interact with one or more memory modules of computing device 104, to receive data from other components of the system 100, transmit data to other components of system 100, and perform functions for web browsing data visualization in a 3D virtual environment as described herein. As mentioned above, computing device 104 includes user interface (UI) module 106, environment rendering module 108, and panel manager module 110 that execute on one or more processors of computing device 104. In some embodiments, modules 106, 108, 110 are specialized sets of computer software instructions programmed onto one or more dedicated processors in computing device 104 and can include specifically designated memory locations and/or registers for executing the specialized computer software instructions.

Although modules 106, 108, 110 are shown in FIG. 1 as executing within a single computing device 104, in some embodiments the functionality of modules 106, 108, 110 can be distributed among a plurality of computing devices. As shown in FIG. 1, computing device 104 enables modules 106, 108, 110 to communicate with each other, and with database 112, in order to exchange data for the purpose of performing the described functions. It should be appreciated that any number of computing devices, arranged in a variety of architectures, resources, and configurations (e.g., networked computing, cluster computing, virtual computing, cloud computing) can be used without departing from the scope of the technology described herein. In some embodiments, computing device 104 can be a desktop or laptop computer coupled to 3D viewing device 102 via a physical connection. In some embodiments, computing device 104 can be a server computing device that is in a separate physical location from the user wearing 3D viewing device 102—in these embodiments, 3D viewing device 102 communicates with computing device 104 via a wired and/or wireless network (e.g., the Internet). In still other embodiments, the functionality of computing device 104 described herein can be included in 3D viewing device 102, such that 3D viewing device 102 is configured to render the 3D virtual environment, detect input from the user wearing device 102, and perform other functions described herein. In some embodiments, 3D viewing device 102 and/or computing device 102 can include graphical processing unit (GPU) hardware that is configured to render the 3D virtual environment. In some embodiments, one or more of modules 106, 108, 110 is built upon the Unity™ 3D Development software platform, available from Unity Technologies. Exemplary functionality of modules 106, 108, 110 is described in detail below.

Database 112 is a computing module embedded in and/or coupled to computing device 104 and which is configured to receive, generate, store, and provide for retrieval specific segments of data relating to the process of web browsing data visualization in a 3D virtual environment as described herein. In some embodiments (as shown in FIG. 1), all or a portion of database 112 can be integrated with computing device 104. In some embodiments, database 112 can be located on a separate computing device or devices, available either local connection or remote connection (e.g., cloud-based services). In some embodiments, all or a portion of database 112 can be integrated into 3D viewing device 102. Database 112 can comprise one or more data repositories configured to store portions of data used by other components of system 100, as will be described in greater detail below. In some embodiments, database 112 stores computing files in memory and/or on disk. For example, database 112 can be remote accessed via a LAN/WAN, or database 112 can be internal to computing device 104.

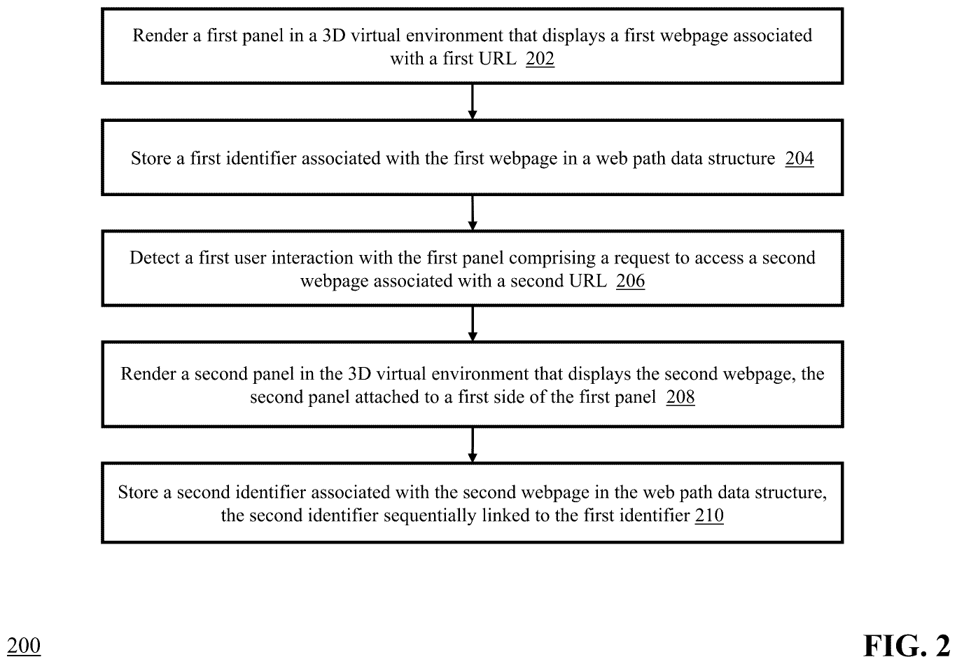

FIG. 2 is a flow diagram of a computerized method 200 of web browsing data visualization in a 3D virtual environment, using system 100 of FIG. 1. As can be appreciated, 3D viewing device 102 can provide functionality to enable a wearer of the device 102 to launch and interact with software applications, either installed locally on device 102 or made available by computing device 104. An exemplary software application is a web browsing application (e.g., Safari™ available from Apple, Inc., or Meta Quest Browser™ available from Meta Platforms, Inc.) that receives input from the user, establishes a connection to a remote server via a communication network, and requests content (e.g., a web page) from the remote server for display to the user. In some embodiments, the input provided by the user comprises a uniform resource locator (URL) defining the web address for the web page and/or remote web server. In some embodiments, the remote server is an external, publicly available web server that provides web page content to computing device 104 and/or 3D viewing device 102. In other embodiments, the remote server is an internal server that is on a same local network (e.g., an intranet) as the 3D viewing device 102 and/or computing device 104.

As one example, a user puts on 3D viewing device 102 and establishes a connection to computing device 104. Environment rendering module 108 generates a 3D virtual environment for display to the user via the viewing device. Generally, the 3D virtual environment comprises a 3D setting, such as a landscape or room, in which the user is placed. In some embodiments, the initial 3D virtual environment displayed to the user comprises a 3D menu of one or more software applications available for use. The user launches a web browsing application and provides input to the web browsing application in the form of a first URL (e.g., www.google.com). For example, the user can interact with a virtual keyboard displayed in the 3D environment to enter the first URL. UI module 106 of computing device 104 captures the user input and provides the first URL to the web browsing application, which establishes a connection via computing device 104 to a remote server at the first URL that hosts web page content. The remote server provides the requested web page content to environment rendering module 108 of computing device 104.

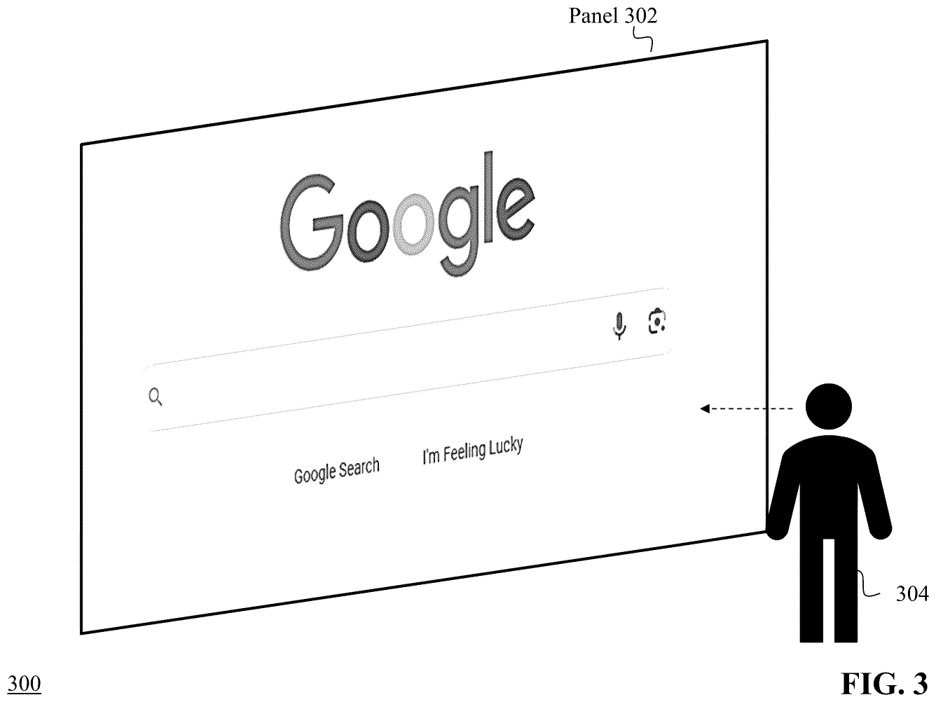

Environment rendering module 108 renders (step 202) a first panel in the 3D virtual environment that displays a first webpage associated with the first URL. For example, when the first URL is www.google.com, environment rendering module 108 can render a first panel in the 3D environment that comprises the main Google™ search page. Typically, module 108 creates a 3D object in the environment to be used as the first panel—such as a freestanding 3D panel positioned in front of the user's viewpoint in the 3D environment. FIG. 3 is a diagram of a 3D environment 300 depicting a requested webpage as a first panel 302, as rendered by environment rendering module 108. As shown in FIG. 3, the first panel 302 is rendered as a 3D object (e.g., a ‘wall’) arranged in front of a user avatar 304 facing toward the panel 302. It should be appreciated that the user avatar 304 displayed in FIG. 3 is for illustrative purposes only. In some embodiments, the user avatar 304 is not rendered by module 108 and/or the user does not see the user avatar 304 when interacting with the 3D environment 300. Instead, the user views the first panel 302 in the 3D environment from a first-person perspective, as if the user was directly standing in front of the panel.

When environment rendering module 108 generates the first panel, panel manager module 110 of computing device 104 stores (step 204) a first identifier associated with the first webpage in a web path data structure. Generally, a web path data structure defines the hierarchical relationships between 3D panels generated and rendered by module 108 during one or more web browsing sessions for the user. The web path data structure can be considered a browsing ‘path’ or ‘journey’ (i.e., the sequence of webpages and/or content) that the user interacts with during a particular session or sessions. For each webpage rendered as a panel in the 3D environment by the environment rendering module 108, panel manager module 110 generates and stores an identifier in the web path data structure that corresponds to the panel. In some embodiments, the identifier comprises a numeric or alphanumeric ID that uniquely identifies the panel in the web path data structure (e.g., a PanelID). In some embodiments, the identifier is a multi-value data element that contains the numeric/alphanumeric ID, a path value, and a sequence value. The path value denotes a specific path or sub-path within the overall web path data structure in which the user visited the associated webpage. The sequence value denotes the sequence in which the webpage was visited on the specific path.

In some embodiments, when panel manager module 110 loads a new webpage, environment rendering module 108 is triggered to create a new panel using a panel management object class. Each panel has a PanelInfo Object attached to enable examination of panel data. The following is an example of the classes used to create a new PanelInfo object:
PanelId: the unique ID for the panel;
ParentPanelId: the unique ID of the parent panel;
URL: the URL assigned to the panel;
Position Right: the position on the X axis;
Position Up: the position on the Y axis;
Position Forward: the position on the Z axis;
Rotation Right: the rotation on the X axis;
Rotation Up: the rotation on the Y axis;
Rotation Forward: the rotation on the Z axis;
IsPrivate: in some embodiments, the panel URL requires authentication by the user. To capture that a login is needed, so that they may be able to log back in again, the user would be brought back to the webpage where the login occurs before enabling visibility to the content on the subsequent panels that required authentication. The panels that follow the login, can either be loaded as greyed out or they could be the last image of them before the last logout;
PathId: unique ID of the path of the panel;
SequenceId: Where panel is in its path;
Arguments (used to visually differentiate the paths in 3D space, other values are possible):
   R: Red color value;
   G: Green color value;
   B: Blue color value;
   A: Alpha color value;
List Visits:
   VisitId: unique visit ID;
   VisitDateTime: the date and time of the visit;
   VisitTimeSpan: the time spent on this visit.
List ChildPanelIds: List of direct children PanelIDs.

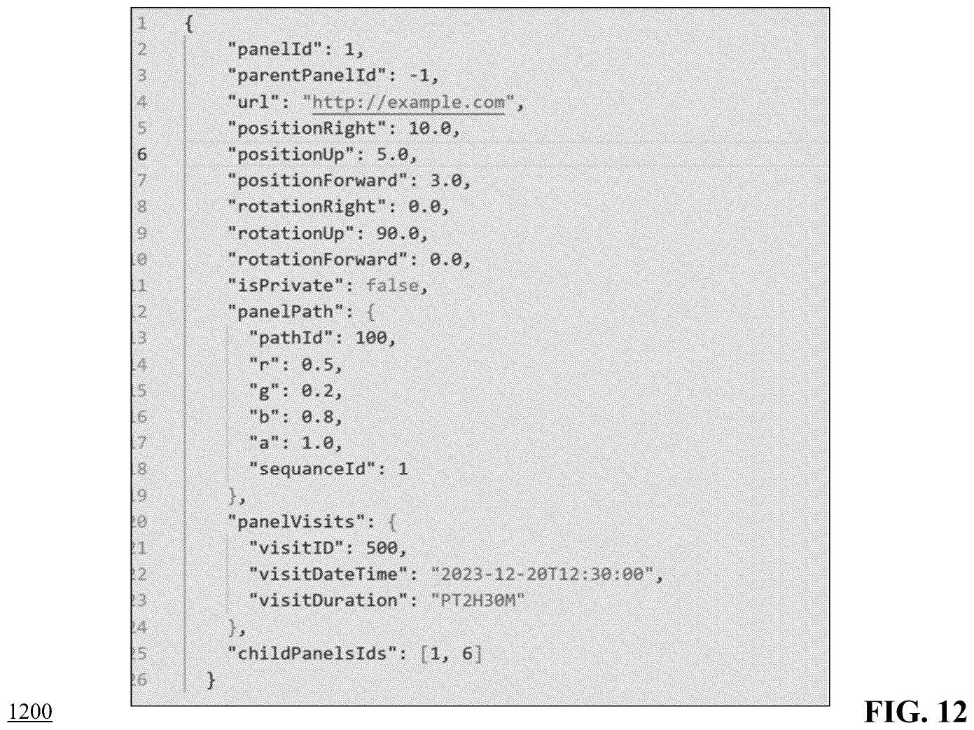

In some embodiments, each node in the web path data structure is stored in database in a structured format (e.g., JSON). FIG. 12 is an exemplary data format 1200 for representing a node in a web path data structure as stored in database 112.

It should be appreciated that panel manager module 110 can capture other attributes relating to each panel so that contextual analytics can be determined from the user's activity in the virtual environment—such as heat maps, eye tracking—to show time on a particular webpage and where the user's focus was on the webpage.

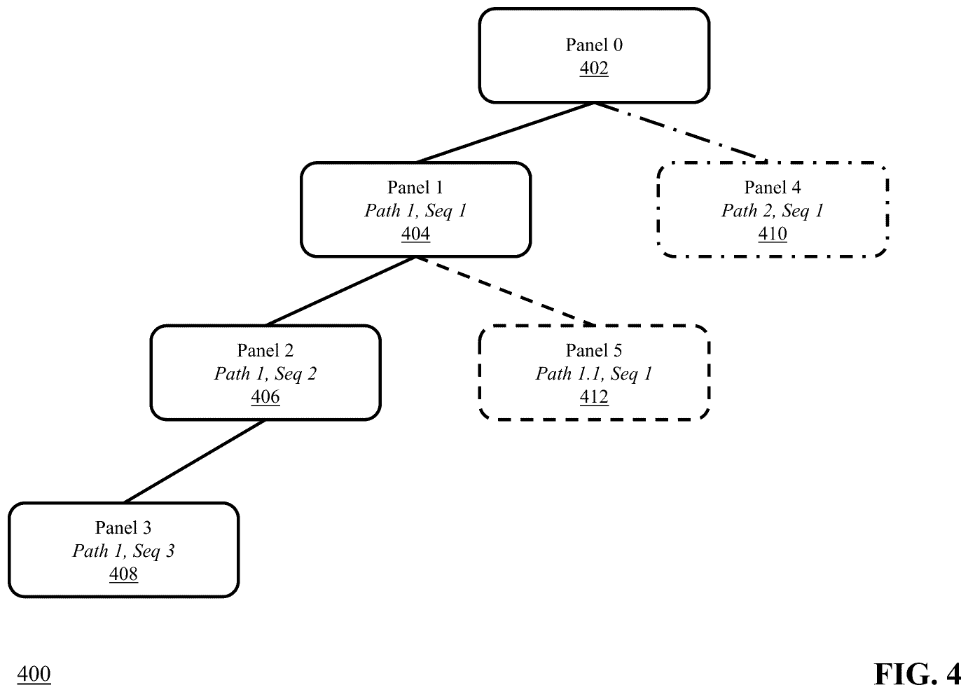

FIG. 4 is a diagram of an exemplary web path data structure 400 generated by panel manager module 110 during one or more browsing sessions for a particular user. As shown in FIG. 4, web path data structure 400 comprises a plurality of panel nodes 402-412 that are connected to each other via edges. Node 402 (‘Panel 0’) is the root node of the structure 400, and this node corresponds to the first webpage visited by the user during one or more web browsing sessions. As the user navigates to subsequent webpages during the session(s), module 110 creates additional panel nodes in the web path data structure according to the path and/or sequence of the visited pages. For example, when the user interacts with Panel 0 in the 3D environment (e.g., clicks a link for a second URL as displayed in the webpage for Panel 0) to navigate to another webpage, UI module 106 of computing device 104 captures the user input and initiates the connection to a web server associated with the second URL. Panel manager module 110 creates a new node 404 in web path data structure for the webpage at the second URL. This new node 404—Panel 1—has a path value of 1, indicating that the panel is part of the first path created for the browsing session, and a sequence value of 1, indicating that the panel is associated with the first webpage visited as part of the corresponding path. It should be appreciated that a new path can start from any node within the data structure. For example, node 412 (Panel 5) has a path value of 1.1—indicating that the node is part of a sub-path of Path 1, starting from node 404. In this example, the user may have navigated through Path 1 (i.e., from Panel 0 to Panel 1 to Panel 2 to Panel 3, then backtracked to Panel 1 and interacted with a different URL displayed in Panel 1 to traverse to the URL associated with Panel 5. Panel manager module 110 then creates a new sub-path underneath node 404—Path 1.1.

Thus, as can be appreciated, the web path data structure 400 in FIG. 4 comprises three different paths, with panels arranged according to the sequence values:

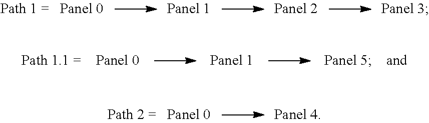

In some embodiments, each node in the web path data structure can contain one or more data elements and/or metadata elements associated with the browsing session and/or individual webpage. For example, each node can include data elements such as: the URL for the corresponding webpage, a timestamp identifying the date/time at which the user accessed the webpage, and the browser application used during the browsing session.

Upon generation of a new panel, module 110 stores the web path data structure in, e.g., database 112 so that the structure can be used in both the current web browsing session and to enable the user to resume an in-progress web browsing session in the future. As mentioned above, the web path data structure can comprise panels and webpages from multiple web browsing sessions. A user may be performing research on a certain topic or subject matter during a first web browsing session and want to resume the research where they left off during a second web browsing session. When the user activates the web browsing application to start the second session, panel manager module 110 can retrieve the web path data structure associated with the first session and environment rendering module 108 can re-create the 3D environment, including the 3D panels for each of the webpages in the web path, for display to the user.

Turning back to FIG. 2, once environment rendering module 108 renders the first panel in the 3D environment for display to the user of 3D viewing device 102, the web path data structure for the web browsing session comprises a single node (Panel 0). Using the example of FIG. 3, the web path data structure contains a node for first panel 302 with the URL ‘www.google.com.’ The user can move within the virtual environment in order to view and interact with the webpage in the first panel. For example, the user can move toward, away from, or parallel to the first panel in one or more directions. The user can move the first panel within the virtual environment, e.g., by using control device 103 to grasp, push, rotate, or slide the first panel. The user can direct their gaze to certain areas or aspects of the first panel by, e.g., moving their head—which triggers one or more sensors in the 3D viewing device 102 to adjust the display of the virtual environment to match the user's perspective. As the user moves within the 3D environment, environment rendering module 108 and/or panel manager module 110 can track the user's gaze and/or movements with respect to the first panel, as well as any movement of the first panel itself, and record the information in database 112. For example, if the user's gaze is directed toward the first panel, modules 108 and/or 110 can capture the amount of time elapsed while the user is looking at the first panel and record the elapsed time in the corresponding panel node of the web path data structure. Similarly, when environment rendering module 108 generates the 3D object for the first panel, module 108 can record positional information in x-y-z coordinates associated with the panel in the 3D environment (e.g., transform, pose, orientation, rotation, etc.)) in the corresponding panel node. If the user moves the first panel, module 108 can capture the movement coordinates in the corresponding panel node.

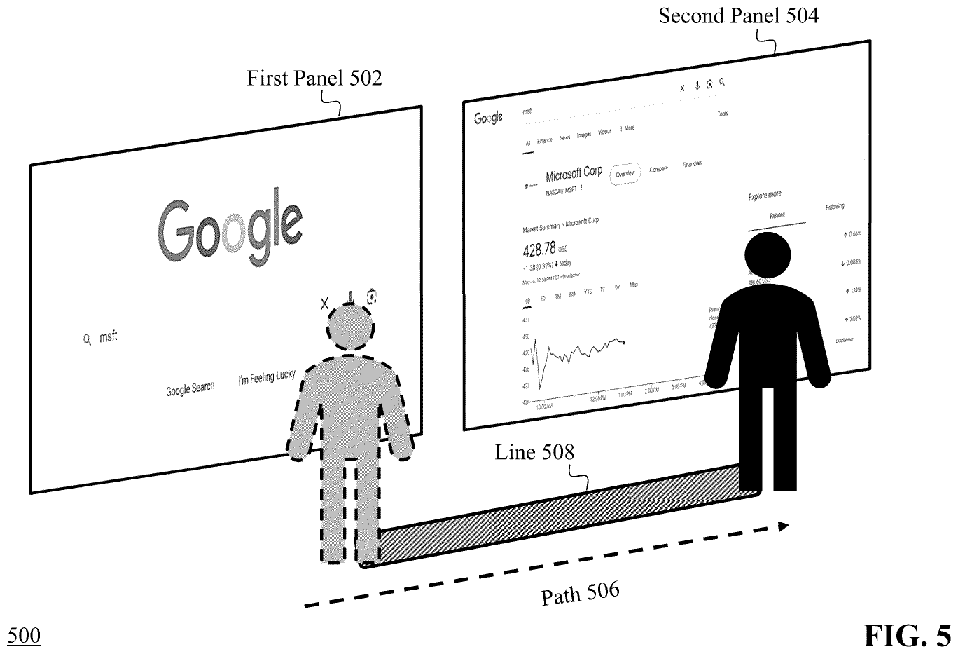

As mentioned previously, the user may interact with the webpage in the first panel by activating a function or link on the webpage to initiate a request to navigate to another webpage. UI module 106 detects (step 206) a first user interaction with the first panel comprising a request to access a second webpage associated with a second URL. FIG. 5 is a diagram of a 3D environment 500 depicting a first webpage in a first 3D panel 502 and a second webpage in a second 3D panel 504, as rendered by environment rendering module 108. As an example, the user may want to search for the current intraday stock price for Microsoft stock (ticker symbol MSFT). The user can enter the ticker symbol as a search string into input field 510 on www.google.com and click the ‘Google Search’ button 512 to request results from the search engine. UI module 106 captures the user input and issues a request comprising the search string to the search engine web server. Upon receiving the search results webpage from the web server, panel manager module 110 creates a new node in the web path data structure with the URL for the search results webpage and connects the new node to the node for the first panel as part of the same path.

Environment rendering module 108 renders (step 208) a second panel in the 3D virtual environment that displays the second webpage, the second panel arranged in proximity to the first panel with a same orientation to the viewer as the first panel and extending in a first direction in the 3D environment. Module 108 creates a new 3D panel object (i.e., second panel 504) in the virtual environment 500 for the search results webpage and positions the new 3D panel object 504 in proximity to one side of the first panel 502. The user can then move within the virtual environment to view the second panel 504—for example, the user can ‘walk’ away from first panel 502 toward second panel 504. The user can stop when they are positioned in front of and facing the second panel 504—thereby following path 506. In some embodiments, second panel 504 is not attached to first panel 502. Instead, second panel 504 is positioned in proximity to first panel 502 and arranged in a same orientation as first panel 502. This may be useful to enable the user to move in between panels in the 3D environment to view panels in other paths (as explained in detail below. In other embodiments, second panel 502 is attached to first panel 502 such that, e.g., the left side of second panel 504 is connected to the right side of first panel 502.

Environment rendering module 108 can also render a visual indicator in the 3D environment that tracks the movement of the user between panels. As shown in FIG. 5, module 108 renders line 508 on, e.g., the floor of the 3D space that matches the movement of the user as they ‘walk’ from first panel 502 to second panel 504. In some embodiments, line 508 is visible to the user so they can see the movement path taken during the web browsing session. In some embodiments, line 508 is color coded according to the specific path assigned to each panel—so that the user can quickly determine the different paths they have created during a session. It should be appreciated that module 108 can render line 508 in any position and/or orientation in the 3D environment—for example, line 508 can be rendered on the floor, ceiling, or other surface in the environment or line 508 can be floating in front of or above panels 502, 504.

Once the second panel is rendered in the virtual environment, panel manager module 110 stores (step 210) a second identifier associated with the second webpage in the existing web path data structure for the browsing session(s) of the user. The second identifier is sequentially linked to the first identifier in the web path data structure, e.g., through the Sequence values assigned to each panel and the edges that connect the panel nodes. Using the Path values and Sequence values, environment rendering module 108 and panel manager module 110 can traverse the web path data structure to determine a user's browsing journey.

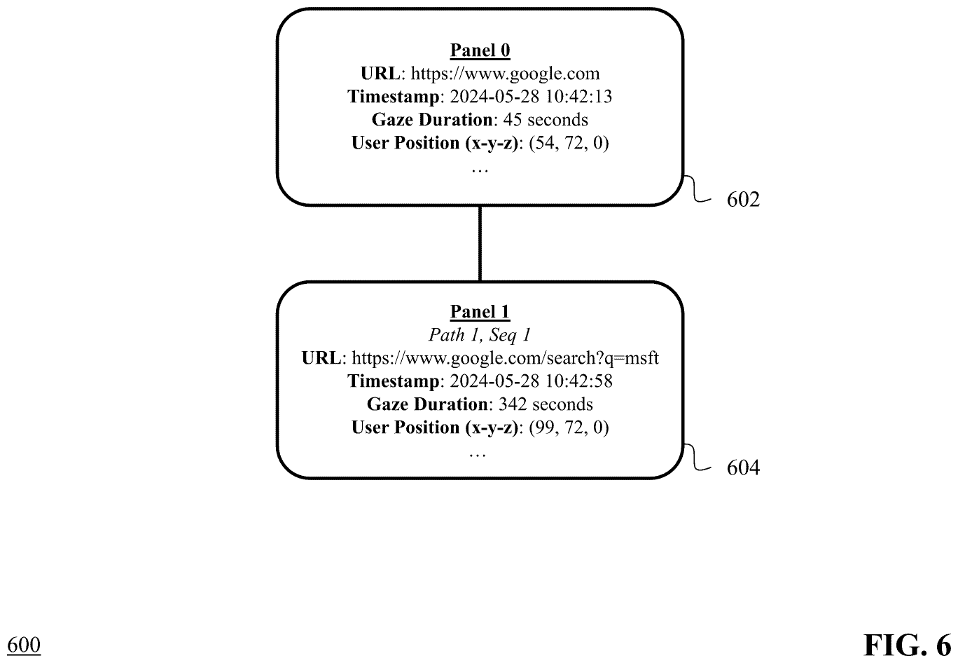

As mentioned above, computing device 104 can track the user's gaze, movements, gestures, and other data via 3D viewing device 102 and record this data in the web path data structure for the web browsing session. FIG. 6 is a diagram of the web path data structure 600 corresponding to the first panel and second panel of FIG. 5. As shown in FIG. 6, web path data structure 600 comprises two nodes: node 602 corresponding to first panel 502 and node 604 corresponding to second panel 504. Each node 602, 604 includes data associated with the panel and user's activity with respect to the panel—such as URL, timestamp, gaze duration, and user position. Generally, it is preferable (although not required) that panels with the same Path value (i.e., Path 1) are arranged in the same orientation in 3D space such that the sequence of panels (as denoted by the Sequence value) can be traversed along a single direction—as indicated by path 506 in FIG. 5.

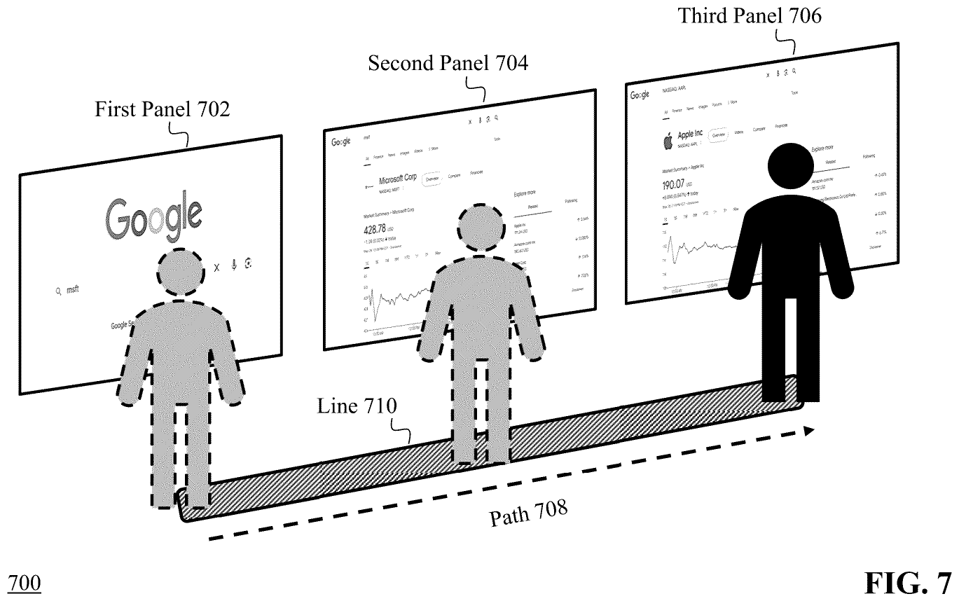

As described previously, a user can navigate to a plurality of webpages along a single path and/or generate multiple browsing paths during one or more web browsing sessions. FIG. 7 is a diagram of a 3D environment 700 depicting a first webpage in a first 3D panel 702, a second webpage in a second 3D panel 704, and a third webpage in a third 3D panel 706, as rendered by environment rendering module 108. In this example, after viewing information relating to Microsoft stock in second panel 704, the user clicks a link in the panel 704 to view information about Apple stock (ticker AAPL). UI module 106 captures the user input and issues a request comprising the link URL to the web server. Upon receiving the link activation request, web server transmits the requested AAPL webpage to computing device 104. Panel manager module 110 creates a new node in the web path data structure with the URL for the AAPL webpage and connects the new node to the node for the second panel as part of the same path.

Environment rendering module 108 renders a third panel in the 3D virtual environment for display of the third webpage. As shown in FIG. 7, third panel 706 is arranged in proximity to the second panel with a same orientation to the viewer as the second panel and extending in the same direction in the 3D environment. Module 108 creates a new 3D panel object in the virtual environment 500 for the AAPL webpage and positions the new 3D panel object 706 in proximity to one side of the second panel 704. The user can then move within the virtual environment to view the third panel 706—for example, the user can ‘walk’ away from second panel 704 toward third panel 706. The user can stop when they are positioned in front of and facing the third panel 504—thereby following path 708. In some embodiments, module 108 also generates line 710 on the floor of the 3D space that matches the movement of the user as they ‘walk’ from second panel 704 to third panel 706.

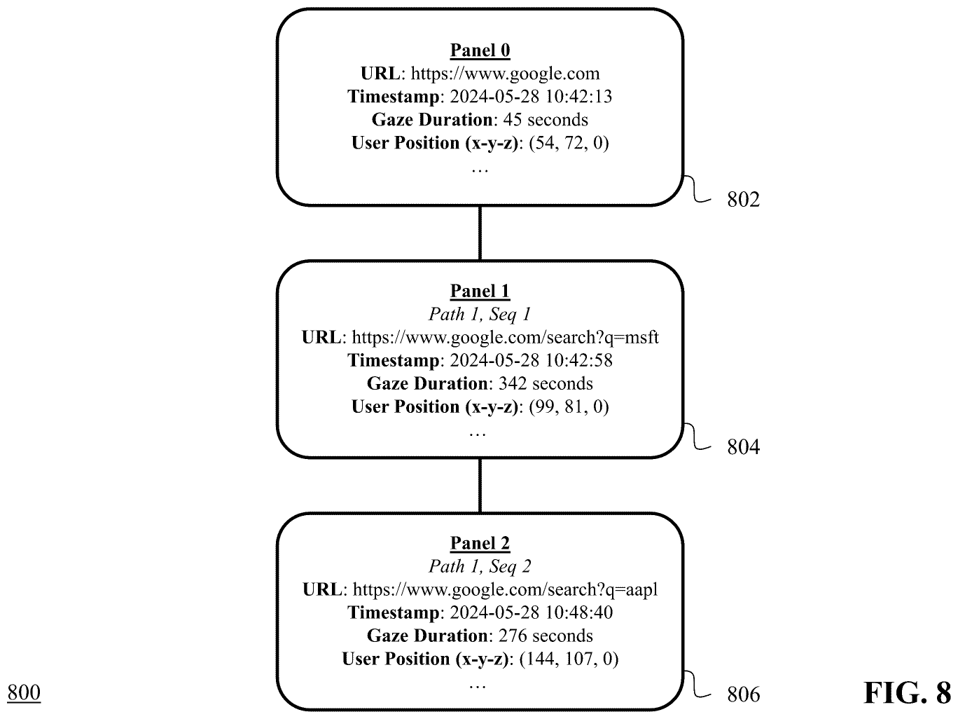

FIG. 8 is a diagram of the web path data structure 800 corresponding to the first, second, and third panels of FIG. 7. As shown in FIG. 8, web path data structure 800 comprises three nodes: node 802 corresponding to first panel 702, node 804 corresponding to second panel 704, and node 806 corresponding to third panel 706. Each node 702, 704, 706 includes data associated with the panel and user's activity with respect to the panel—such as URL, timestamp, gaze duration, and user position.

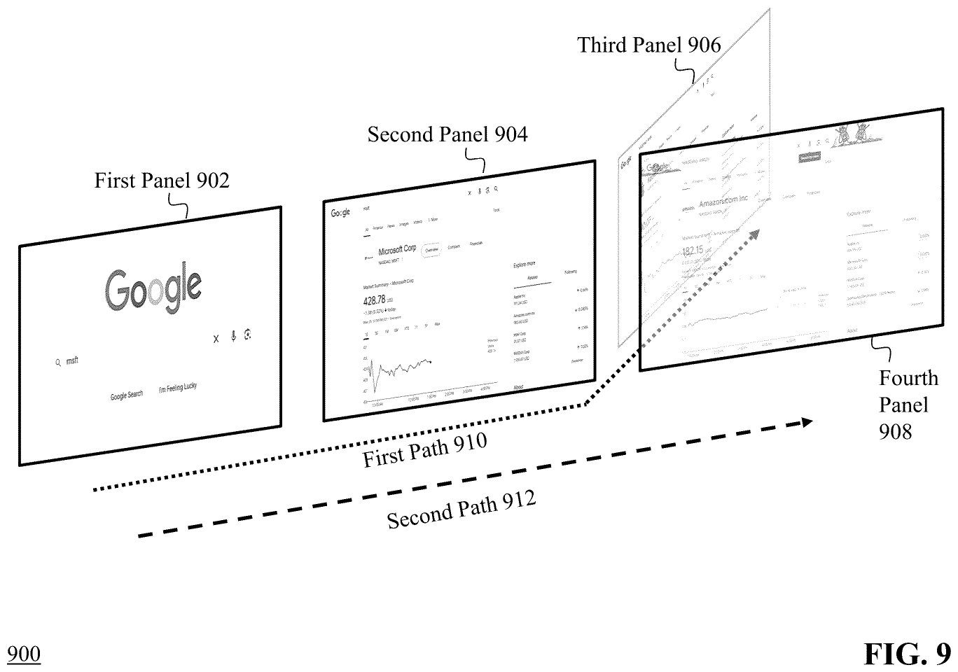

In some circumstances, the user may reach the end of one web browsing path during a browsing session and begin traversing another web browsing path. System 100 is configured to capture each of a plurality of browsing paths and dynamically render each of the paths as sets of panels in the virtual environment—creating a maze-like structure for the user to explore. FIG. 9 is a diagram of a 3D environment 900 depicting a plurality of panels 902, 904, 906 and 908 that make up two web browsing paths 910 and 912. In this example, the user conducted a first browsing session that generated the webpages in first panel 902, second panel 904 and third panel 906 (see FIGS. 7 and 8 above). The user subsequently returns to second panel 904 (either during the same web browsing session or a future web browsing session) and clicks a different link on the webpage displayed in second panel 904 to view information about Amazon stock (ticker symbol AMZN).

UI module 106 captures the user input and issues a request comprising the link URL to the web server. Upon receiving the link activation request, web server transmits the requested AMZN webpage to computing device 104. Panel manager module 110 creates a new node in the web path data structure with the URL for the AMZN webpage and connects the new node to the node for the second panel as part of a new path (i.e., Path 1.1).

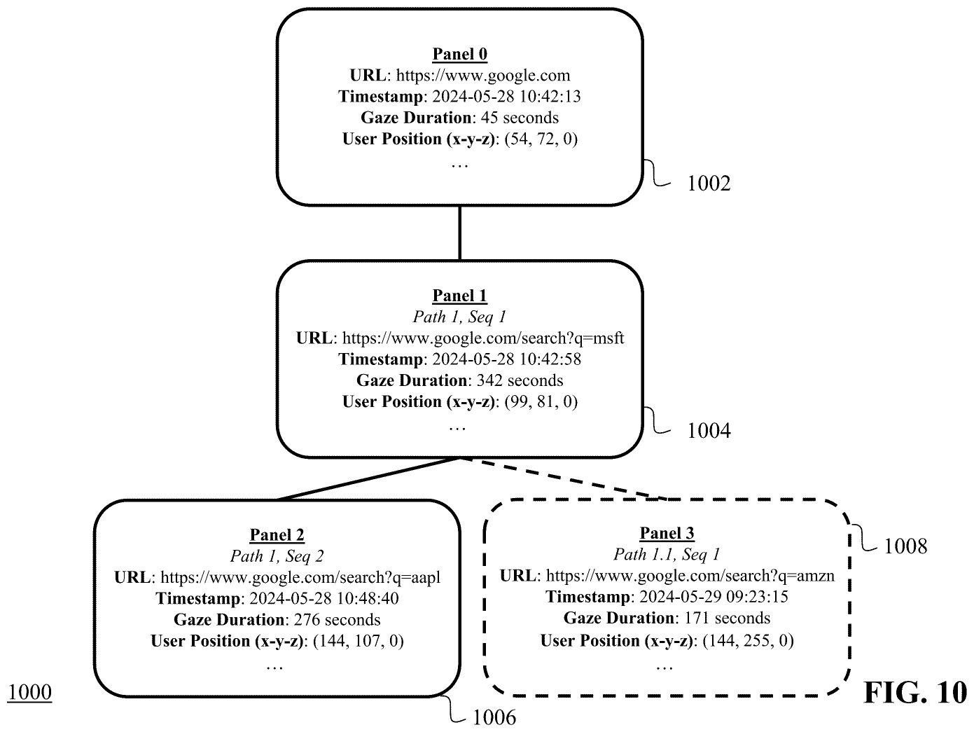

Environment rendering module 108 renders a fourth panel in the 3D virtual environment for display of the AMZN webpage. As shown in FIG. 9, third panel 906 is rotated counterclockwise from its existing position in the same line as first panel 902 and second panel 904. While third panel 906 is still in proximity to the right side of second panel 904, third panel 906 is now located at a different angle extending from second panel 904. Module 108 renders fourth panel 908 in the location previously occupied by third panel 906, i.e., in proximity to the second panel with a same orientation to the viewer as the second panel and extending in the same direction in the 3D environment. Module 108 creates a new 3D panel object in the virtual environment 900 for the AMZN webpage and positions the new 3D panel object 908 in proximity to one side of the second panel 904. The two browsing paths generated by the user are shown as paths 910 and 912. It should be appreciated that this type of panel rotation and insertion is exemplary, and environment rendering module 108 can employ a variety of different object manipulations when creating a new path and/or adding panels to an existing path without departing from the scope of the technology described herein. FIG. 10 is a diagram of the web path data structure 1000 corresponding to the first, second, third, and fourth panels of FIG. 9. As shown in FIG. 10, web path data structure 1000 comprises four nodes: node 1002 corresponding to first panel 902, node 1004 corresponding to second panel 904, node 1006 corresponding to third panel 906, and node 1008 corresponding to fourth panel 908. Each node 902, 904, 906, 908 includes data associated with the panel and user's activity with respect to the panel—such as URL, timestamp, gaze duration, and user position.

As can be appreciated, an advantage of the technology described herein is providing users with a fully immersive visual user experience for web-based browsing and research. Another advantage of the technology is enabling the re-creation of prior browsing sessions to see not only the path(s) that the user traversed, but also view the user's interaction with certain panels, webpages, and other elements in the 3D environment. In addition, the user can seamlessly resume an earlier browsing session while viewing the full context of their prior research across multiple panels and webpages.

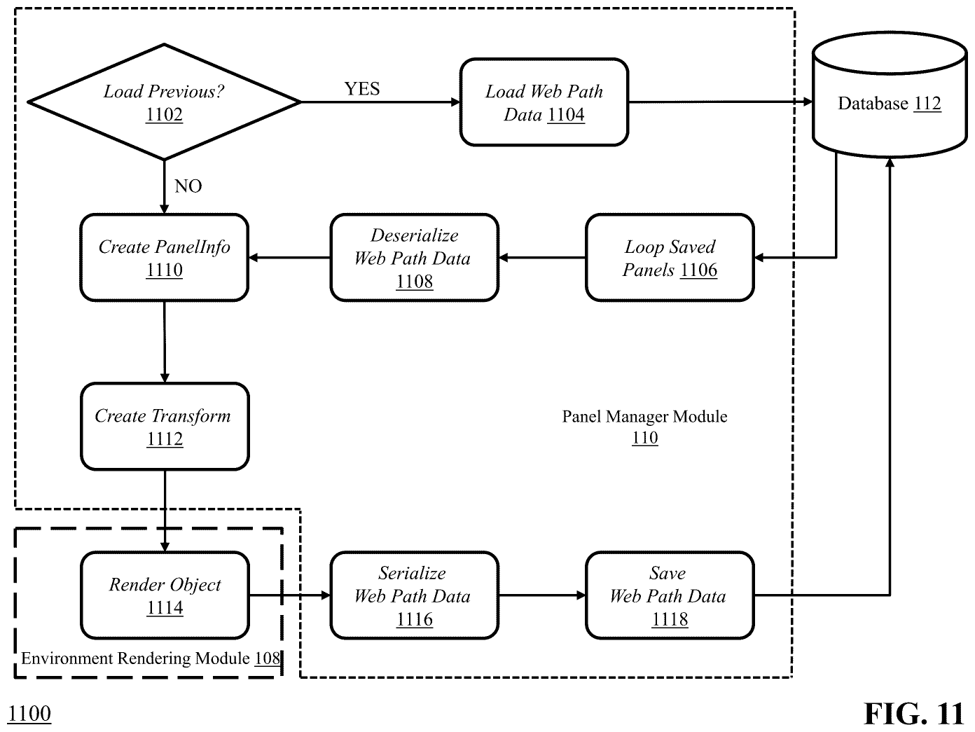

FIG. 11 is a workflow diagram of a computerized method 1100 of creating panels for a web browsing session in a 3D environment, using system 100 of FIG. 1. Panel manager module 110 receives a request from 3D viewing device 102 to initiate a web browsing session and determines (step 1102) whether the request relates to a previous browsing session that the user wants to resume or a new browsing session. If the request is to resume a previous browsing session, module 110 connects to database 112 and loads (step 1104) the web path data structure that is associated with the previous session. Module 110 loops (step 1106) through each panel node in the web path data structure and deserializes (step 1108) the web path data. Module 110 creates (step 1110) the PanelInfo Object for the panel and creates (step 1112) the transform data (e.g., position, orientation, rotation, etc.). Module 110 provides the PanelInfo Object and transform data to environment rendering module 108, which renders (step 1114) the 3D panel in the virtual environment using the provided data. Panel manager module 110 serializes (step 1116) the web path data, including the newly created 3D panel, into the web path data structure and saves (step 1118) the updated web path data structure in database 112. In cases where the user is starting a new browsing session, panel manager module 110 does not load any web path data from database 112 and instead proceeds to step 1110 for creation of a new web path data structure and rendering of a new 3D panel.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account—which allows access to the aforementioned computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application and store relevant data.

Method steps can be performed by one or more processors executing a computer program to perform functions of the invention by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN)), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A system for web browsing data visualization in a 3D virtual environment, the system comprising a computing device having a memory for storing computer-executable instructions and a processor that executes the computer-executable instructions to:
render a first panel in the 3D virtual environment that displays to a user a first webpage associated with a first URL;
store a first identifier associated with the first webpage in a web path data structure;
detect a first user interaction with the first panel from the user, the first user interaction comprising a request to access a second webpage associated with a second URL;
render a second panel in the 3D virtual environment that displays the second webpage, the second panel arranged in proximity to a first side of the first panel with a same orientation to the user as the first panel, and extending in a first direction in the 3D virtual environment; and
store a second identifier associated with the second webpage in the web path data structure, the second identifier sequentially linked to the first identifier.

2. The system of claim 1, wherein the computing device:
detects a user interaction with the second panel, the user interaction comprising a request to access a third webpage associated with a third URL;
renders a third panel in the 3D virtual environment that displays the third webpage, the third panel arranged in proximity to a first side of the second panel with a same orientation to the user as the second panel, and extending from the second panel in the first direction; and
stores a third identifier associated with the third webpage in the web path data structure, the third identifier sequentially linked to the first identifier and the second identifier.

3. The system of claim 2, wherein the computing device:
detects a second user interaction with the first panel, the second user interaction comprising a request to access a fourth webpage associated with a fourth URL;
renders a fourth panel in the 3D virtual environment that displays the fourth webpage, the fourth panel arranged in proximity to a second side of the first panel with a different orientation to the user than the orientation of the first panel, and extending from the first panel in a second direction in the 3D virtual environment; and
stores a fourth identifier associated with the fourth webpage in the web path data structure, the fourth identifier sequentially linked to the first identifier.

4. The system of claim 3, wherein the computing device renders a first line in the 3D virtual environment that traces a first path starting at the first panel, continuing to the second panel, and ending at the third panel.

5. The system of claim 4, wherein the computing device renders a second line in the 3D virtual environment that traces a second path starting at the first panel and ending at the fourth panel.

6. The system of claim 3, wherein the computing device is a headset device comprising one or more of: a virtual reality (VR) headset, a mixed reality (MR) headset, or an augmented reality (AR) headset.

7. The system of claim 6, wherein, for each panel, the headset device tracks a duration that the user's gaze is directed toward the panel and stores the duration for the panel in the web path data structure.

8. The system of claim 6, wherein, for each panel, the headset device tracks a duration that the user is positioned in 3D space in front of the panel and stores the duration for the panel in the web path data structure.

9. The system of claim 2, wherein the computing device:
detects a third user interaction with the second panel, the third user interaction comprising a request to access a fifth webpage associated with a fifth URL;
rotates the third panel in the 3D virtual environment so that the third panel is arranged in proximity to the first side of the second panel with a different orientation to the user than the orientation of the second panel, and extends from the second panel in a second direction;
renders a fifth panel in the 3D virtual environment that displays the fifth webpage, the fifth panel arranged in proximity to the first side of the second panel with the same orientation to the user as the orientation of the second panel, and extending from the second panel in the first direction; and
stores a fifth identifier associated with the fifth webpage in the web path data structure, the fifth identifier sequentially linked to the first identifier and the second identifier.

10. A computerized method of web browsing data visualization in a 3D virtual environment, the method comprising:
rendering, by a computing device, a first panel in the 3D virtual environment that displays to a user a first webpage associated with a first URL;
storing, by the computing device, a first identifier associated with the first webpage in a web path data structure;
detecting, by the computing device, a first user interaction with the first panel from the user, the first user interaction comprising a request to access a second webpage associated with a second URL;
rendering, by the computing device, a second panel in the 3D virtual environment that displays the second webpage, the second panel arranged in proximity to a first side of the first panel with a same orientation to the user as the first panel, and extending in a first direction in the 3D virtual environment; and
storing, by the computing device, a second identifier associated with the second webpage in the web path data structure, the second identifier sequentially linked to the first identifier.

11. The method of claim 10, wherein the computing device:
detects a user interaction with the second panel, the user interaction comprising a request to access a third webpage associated with a third URL;
renders a third panel in the 3D virtual environment that displays the third webpage, the third panel arranged in proximity to a first side of the second panel with a same orientation to the user as the second panel, and extending from the second panel in the first direction; and
stores a third identifier associated with the third webpage in the web path data structure, the third identifier sequentially linked to the first identifier and the second identifier.

12. The method of claim 11, wherein the computing device:
detects a second user interaction with the first panel, the second user interaction comprising a request to access a fourth webpage associated with a fourth URL;
renders a fourth panel in the 3D virtual environment that displays the fourth webpage, the fourth panel arranged in proximity to a second side of the first panel with a different orientation to the user than the orientation of the first panel, and extending from the first panel in a second direction in the 3D virtual environment; and
stores a fourth identifier associated with the fourth webpage in the web path data structure, the fourth identifier sequentially linked to the first identifier.

13. The method of claim 12, wherein the computing device renders a first line in the 3D virtual environment that traces a first path starting at the first panel, continuing to the second panel, and ending at the third panel.

14. The method of claim 13, wherein the computing device renders a second line in the 3D virtual environment that traces a second path starting at the first panel and ending at the fourth panel.

15. The method of claim 12, wherein the computing device is a headset device comprising one or more of: a virtual reality (VR) headset, a mixed reality (MR) headset, or an augmented reality (AR) headset.

16. The method of claim 15, wherein, for each panel, the headset device tracks a duration that the user's gaze is directed toward the panel and stores the duration for the panel in the web path data structure.

17. The method of claim 15, wherein, for each panel, the headset device tracks a duration that the user is positioned in 3D space in front of the panel and stores the duration for the panel in the web path data structure.

18. The method of claim 11, wherein the computing device:
detects a third user interaction with the second panel, the third user interaction comprising a request to access a fifth webpage associated with a fifth URL;
rotates the third panel in the 3D virtual environment so that the third panel is arranged in proximity to the first side of the second panel with a different orientation to the user than the orientation of the second panel, and extends from the second panel in a second direction;
renders a fifth panel in the 3D virtual environment that displays the fifth webpage, the fifth panel arranged in proximity to the first side of the second panel with the same orientation to the user as the orientation of the second panel, and extending from the second panel in the first direction; and
stores a fifth identifier associated with the fifth webpage in the web path data structure, the fifth identifier sequentially linked to the first identifier and the second identifier.
